(19) United States
(12) Patent Application Publication
(10) Pub. No.: US 2023/0413844 A1
(43) Pub. Date: Dec. 28, 2023

(54) OIL AND/OR FAT COMPOSITION, AND BEVERAGE OR FOOD PRODUCT

(71) Applicant: MIYOSHI OIL & FAT CO., LTD., Tokyo (JP)

(72) Inventors: Sae Fujinami, Tokyo (JP); Motoko Ueyama, Tokyo (JP); Yusuke Tomita, Tokyo (JP); Akira Ohta, Tokyo (JP); Masanori Shida, Tokyo (JP)

(21) Appl. No.: 18/252,345

(22) PCT Filed: Nov. 22, 2021
(86) PCT No.: PCT/JP2021/042740

§ 371 Date: May 9, 2023

(30) Foreign Application Priority Data
Nov. 20, 2020 (JP) 2020-193293

(51) Int. Cl. A23D 9/007; A23L 2/38

(52) U.S. Cl. CPC A23D 9/007; A23L 2/38

(57) ABSTRACT

An oil and/or fat composition with good richness, aroma and a suppressed off-flavor. The oil and/or fat composition contains hydroxymethylfurfural, methional, phenylethanal, and ethanol; the hydroxymethylfurfural content in the oil and/or fat composition is 100 to 7000 ppm; the methional content in the oil and/or fat composition is equal to or greater than 1 ppm; and the solid fat content in the oil and/or fat composition is equal to or less than 10% at 10° C.

### TECHNICAL FIELD

The present invention relates to an oil and/or fat composition, and a food or drink product.

### BACKGROUND ART

Flavored oils are known as seasonings that enhance palatability of various types of food or drink products. The flavored oils refer to liquid oils provided with desired flavors. For the flavoring, various materials are used (for example, see Patent Documents 1 and 2).
Patent Document 1: Japanese Unexamined Patent Application, Publication No. 2020-68657
Patent Document 2: Japanese Unexamined Patent Application, Publication No. 2008-92916

### DISCLOSURE OF THE INVENTION

### Problems to be Solved by the Invention

However, there has been a need for a flavored oil with a flavor that has not been known so far.

The inventors of the present invention, in developing flavors that had not been sufficiently investigated so far, focused on richness, aroma, and the smallness of off-flavors.

The present invention was made in light of the above circumstances, an object of the present invention is to provide an oil and/or fat composition with good richness, aroma, and a suppressed off-flavor.

### Means for Solving the Problems

The inventors of the present invention have found that the aforementioned problems can be solved by blending certain ingredients into an oil and/or fat, and this finding has led to the completion of the invention. More specifically, the present invention provides the following aspects.
(1) An oil and/or fat composition including: hydroxymethylfurfural, methional, phenylethanal, and ethanol, the content of the hydroxymethylfurfural in the oil and/or fat composition being 100 ppm or more and 7,000 ppm or less; the content of the methional in the oil and/or fat composition being 1 ppm or more;
the oil and/or fat composition having a solid fat content of 10% or less at 10° C.
(2) The oil and/or fat composition according to (1), wherein the phenylethanal content in the oil and/or fat composition is 7 ppm or more and 140 ppm or less.
(3) The oil and/or fat composition according to (1) or (2), wherein the ethanol content in the oil and/or fat composition is 1,100 ppm or more and 14,000 ppm or less.
(4) The oil and/or fat composition according to any one of (1) to (3), wherein the mass ratio of the ethanol to the hydroxymethylfurfural is 0.30 or more and 100.00 or less.
(5) A food or drink product including the oil and/or fat composition according to any one of (1) to (4).
(6) The food or drink product according to (5), wherein the food or drink product is a plastic oil and/or fat composition.

### Effects of the Invention

According to the present invention, an oil and/or fat composition with good richness, aroma, and a suppressed off-flavor is provided.

### PREFERRED MODE FOR CARRYING OUT THE INVENTION

Embodiments of the present invention will be explained below, but the present invention is not limited to the embodiments.

<Oil and/or Fat Composition>

The oil and/or fat composition according to the present invention is obtained by blending various ingredients into an oil and/or fat, and satisfies all of the following requirements.
(Requirement 1) The oil and/or fat composition contains hydroxymethylfurfural, methional, phenylethanal, and ethanol.
(Requirement 2) The hydroxymethylfurfural content in the oil and/or fat composition is 100 ppm or more and 7000 ppm or less.
(Requirement 3) The methional content in the oil and/or fat composition is 1 ppm or more.
(Requirement 4) The solid fat content in the oil and/or fat composition is 10% or less at 10° C.

The inventors of the present invention have found that a combination of the four ingredients specified in the above (Requirement 1) surprisingly provides good richness and aroma to an oil and/or fat. Furthermore, the inventors have found that the richness is particularly improved by adjusting the hydroxymethylfurfural content in the oil and/or fat composition so as to satisfy the above (Requirement 2), and that the aroma is particularly improved by adjusting the methional content in the oil and/or fat composition so as to satisfy the above (Requirement 3).

In the present invention, the “richness” means a flavor that evokes a food or drink product (beef, red wine, etc.) having a richness, which is massive and thick. Such a flavor usually lasts for a relatively long time after taking the oil and/or fat composition into the mouth (e.g. 10 seconds or longer from the time of taking the composition into the mouth).

In the present invention, the term “aroma” means a flavor that lightly smells and evokes burnt soy sauce. Such a flavor is usually perceived immediately after the oil and/or fat composition is taken into the mouth (e.g. within 3 seconds from the time of taking the composition into the mouth).

In the present invention, the term “off-flavor” means a flavor that is uncomfortable as a flavor of an oil and/or fat composition or a food or drink product (e.g. a tingly bitter taste, a too strong smell of alcohol, grass, etc.). The oil and/or fat composition according to the present invention has a suppressed off-flavor or no off-flavor.

Each of richness, aroma, and off-flavor of the oil and/or fat composition is evaluated by the method described in Examples.

In the present invention, the “solid fat content at 10° C.” is measured in accordance with “2.2.9-2013 Solid Fat Content (NMR method)” in Standard Oil and/or Fat Analysis Method (Japan Oil Chemists' Society). The term “oil and/or fat composition with solid fat content of 10% or less at 10° C.” means that the oil and/or fat composition is normally in a liquid state at 10° C.

The solid fat content in the oil and/or fat composition according to the present invention at 10° C. is preferably 3% or less.

The oil and/or fat composition according to the present invention will be explained below in detail.

### (Hydroxymethylfurfural)

The oil and/or fat composition according to the present invention contains hydroxymethylfurfural (chemical formula: C₆H₆O₃). The International Union of Pure and Applied chemistry (IUPAC) name of hydroxymethylfurfural is 5-(hydroxymethyl)-2-furaldehyde. Hydroxymethylfurfural is known to have a fragrance that evokes butter or caramel.

The hydroxymethylfurfural content in the oil and/or fat composition according to the present invention is 100 ppm or more and 7000 ppm or less. If the hydroxymethylfurfural content in the oil and/or fat composition according to the present invention is 100 ppm or more, a sufficient richness can be exhibited. If the hydroxymethylfurfural content in the oil and/or fat composition according to the present invention is 7,000 ppm or less, occurrence of an undesirable flavor (bitterness, etc.) can be prevented. Within the above range, there is a tendency that the more the hydroxymethylfurfural content in the oil and/or fat composition is, the more easily the richness is enhanced.

The lower limit of the hydroxymethylfurfural content in the oil and/or fat composition is preferably 500 ppm or more, more preferably 2500 ppm or more from the viewpoint of facilitating enhancement of the richness.

The upper limit of the hydroxymethylfurfural content in the oil and/or fat composition is preferably 6,000 ppm or less from the viewpoint of facilitating suppression of off-flavors.

Hydroxymethylfurfural according to the present invention may be a synthetic product, or a food or drink containing hydroxymethylfurfural as a part thereof, or an extract.

The hydroxymethylfurfural content in the oil and/or fat composition is identified by the following method called an external standard method, using a solid phase microextraction (SPME) as a gas chromatography. First, four standard samples are prepared, with a hydroxymethylfurfural concentration of 1 ppm, 100 ppm, 1000 ppm, or 10000 ppm respectively. These samples are subjected to a gas chromatography, and a peak area of an ion mass of 126 (molecular ions) is determined to create a calibration curve. Also, the retention time is recorded. Subsequently, the oil and/or fat composition to be measured is subjected to a gas chromatography, and a peak area of the ion mass of 126 (molecular ions) at the same retention time as of the standard sample is determined. The peak area obtained as described above is applied to the calibration curve to identify the hydroxymethylfurfural content in the oil and/or fat composition.

### (Methional)

The oil and/or fat composition according to the present invention contains methional (chemical formula: C₄H₈OS). The IUPAC name of methional is 3-(methylsulfanyl)propanal, which is also referred to as 3-(methylthio)propionaldehyde, 3-(methylmercapto)propionaldehyde, 3-(methylthio)propanal, or 4-thiapentanal. Methional is known to have a roasted odor or a toasted odor.

The methional content in the oil and/or fat composition according to the present invention is 1 ppm or more. If the methional content in the oil and/or fat composition according to the present invention is 1 ppm or more, a sufficient aroma can be exhibited. Within the above range, there is a tendency that the more the methional content in the oil and/or fat composition is, the more easily the aroma is enhanced.

The lower limit of the methional content in the oil and/or fat composition is preferably 2 ppm or more, more preferably 4 ppm or more from the viewpoint of facilitating enhancement of the aroma.

The upper limit of the methional content in the oil and/or fat composition is preferably 300 ppm or less, more preferably 180 ppm or less from the viewpoint of facilitating suppression of off-flavors.

Methional according to the present invention may be a synthetic product, or a food or drink containing methional as a part thereof, or an extract.

The methional content in the oil and/or fat composition is identified by the following method called an external standard method, using an SPME as a gas chromatography. First, four standard samples are prepared, with a methional concentration of 0.01 ppm, 1 ppm, 10 ppm, or 1000 ppm respectively. These samples are subjected to a gas chromatography, and a peak area of an ion mass of 104 (molecular ions) is determined to create a calibration curve. Also, the retention time is recorded. Subsequently, the oil and/or fat composition to be measured is subjected to a gas chromatography, and a peak area of the ion mass of 104 (molecular ions) at the same retention time as of the standard sample is determined. The peak area obtained as described above is applied to the calibration curve to identify the methional content in the oil and/or fat composition.

### (Phenylethanal)

The oil and/or fat compositions according to the present invention contains phenylethanal (chemical formula: C₆H₈O). The IUPAC name of phenylethanal is 2-acetaldehyde, which is also referred to as hyacinthine, α-tolualdehyde, α-toluylaldehyde, benzeneethanal, 2-phenylacetaldehyde, 2-phenylethanal, benzeneacetaldehyde, or phenylacetaldehyde. Phenylethanal is known to have a fragrance that evokes honey, rose, grass, or the like.

There is a tendency that the more the phenylethanal content in the oil and/or fat composition according to the present invention is, the more easily the aroma is enhanced.

The lower limit of the phenylethanal content in the oil and/or fat composition is preferably 7 ppm or more, more preferably 15 ppm or more from the viewpoint of facilitating enhancement of the aroma.

The upper limit of the phenylethanal content in the oil and/or fat composition is preferably 140 ppm or less, more preferably 90 ppm or less from the viewpoint of facilitating suppression of off-flavors.

Phenylethanal according to the present invention may be a synthetic product, or a food or drink containing phenylethanal as a part thereof, or an extract.

The phenylethanal content in the oil and/or fat composition is identified by the following method called an external standard method, using an SPME as a gas chromatography. First, four standard samples are prepared, with a phenylethanal concentration of 1 ppm, 10 ppm, 100 ppm, or 1000 ppm respectively. These samples are subjected to a gas chromatography, and a peak area of an ion mass of 120 (molecular ions) is determined to create a calibration curve. Also, the retention time is recorded. Subsequently, the oil and/or fat composition to be measured is subjected to a gas chromatography, and a peak area of the ion mass of 120 (molecular ions) at the same retention time as of the standard sample is determined. The peak area obtained as described above is applied to the calibration curve to determine the phenylethanal content in the oil and/or fat composition.

### (Ethanol)

The oil and/or fat composition according to the present invention contains ethanol (chemical formula: C₂H₅OH).

There is a tendency that the more the ethanol content in the oil and/or fat composition according to the present invention is, the more easily the effect of the present invention is exhibited, the superior the richness and the aroma are, and the more easily the oil and/or fat composition having a suppressed off-flavor is obtained.

The lower limit of the ethanol content in the oil and/or fat composition is preferably 1100 ppm or more, more preferably 3000 ppm or more from the viewpoint of facilitating exhibition of the effect of the present invention.

The upper limit of the ethanol content in the oil and/or fat composition is preferably 14000 ppm or less, more preferably 10000 ppm or less from the viewpoint of facilitating suppression of off-flavors.

Ethanol according to the present invention may be a synthetic product, or a food or drink containing ethanol as a part thereof, or an extract.

The ethanol content in the oil and/or fat composition is identified by the following method called an external standard method, using an SPME as a gas chromatography. First, four standard samples are prepared, with an ethanol concentration of 100 ppm, 1000 ppm, 10000 ppm, or 20000 ppm respectively. These samples are subjected to a gas chromatography, and a peak area of an ion mass of 45 (molecular ions) is determined to create a calibration curve. Also, the retention time is recorded. Subsequently, the oil and/or fat composition to be measured is subjected to a gas chromatography, and a peak area of the ion mass of 45 (molecular ions) at the same retention time as of the standard sample is determined. The peak area obtained as described above is applied to the calibration curve to determine the ethanol content in the oil and/or fat composition.

### (Ratio of Each Ingredient)

In the oil and/or fat composition according to the present invention, a ratio of each ingredient may satisfy the following conditions.

The lower limit of a mass ratio of ethanol to hydroxymethylfurfural (ethanol/hydroxymethylfurfural) may be preferably 0.30 or higher, more preferably 1.00 or higher, even more preferably 1.30 or higher from the viewpoint of facilitating exhibition of the effect of the present invention.

The upper limit of the mass ratio of ethanol to hydroxymethylfurfural (ethanol/hydroxymethylfurfural) may be preferably 100.00 or lower, more preferably 50.00 or lower, even more preferably 10.00 or lower from the viewpoint of facilitating suppression of off-flavors.

(Oil and/or Fat)

As the oil and/or fat, an edible oil and/or fat is usually used. Examples of such an oil and/or fat include vegetable oils and/or fats, animal oils and/or fats, synthetic oils and/or fats, processed oils and/or fats, and the like. Each of these oils and/or fats may be used alone or in combination of two or more types.

Examples of the vegetable oils and/or fats include rapeseed oil (canola oil), soybean oil, corn oil, sesame oil, perilla oil, linseed oil, peanut oil, safflower oil, high-oleic acid safflower oil, sunflower oil, high-oleic acid sunflower oil, cottonseed oil, grapeseed oil, macadamia nut oil, hazelnut oil, pumpkin seed oil, walnut oil, camellia oil, tea seed oil, perilla seed oil, borage oil, olive oil, rice bran oil, wheat germ oil, coconut oil, cacao butter, palm oil, palm kernel oil, algae oil, and the like.

Examples of the animal oils and/or fats include fish oil (oils and/or fats derived from tuna, mackerel, sardine, bonito, herring, etc.), lard, beef tallow, milk fat, mutton tallow, and the like.

Examples of the synthetic oils and/or fats include medium-chain fatty acid oil, diacylglycerol, and the like.

The processed oils and/or fats may be the aforementioned oils and/or fats processed in a desired way. Examples of such processing include fractionation (e.g. fractionated oil such as fractionated milk fat low melting point part and palm super olein), hardening, ester exchange reaction, and the like. The oil and/or fat may be subjected to one or plurality types of processing.

It is generally known that animal oils and/or fats have superior richness and the like to vegetable oils and/or fats. However, according to the present invention, even when only a vegetable oil and/or fat is used as the oil and/or fat, it is possible to obtain an oil and/or fat composition having a richness and the like equivalent or superior to those of an animal oil and/or fat.

From the viewpoint of facilitating acquisition of the oil and/or fat composition with a solid fat content of 10% or less at 10° C., the oil and/or fat blended into the oil and/or fat composition is preferably a liquid oil. Examples of the liquid oil include rapeseed oil (canola oil), soybean oil, corn oil, sesame oil, perilla oil, linseed oil, peanut oil, safflower oil, high-oleic acid safflower oil, sunflower oil, high-oleic acid sunflower oil, cottonseed oil, grapeseed oil, macadamia nut oil, hazelnut oil, pumpkin seed oil, walnut oil, camellia oil, tea seed oil, perilla seed oil, borage oil, olive oil, rice bran oil, wheat germ oil, and the like.

### (Other Ingredients)

The oil and/or fat composition according to the present invention can contain known food products and food additives that are blended into food or drink products and the like, without interfering with the effect of the present invention. Examples of the food products include saccharides, tea leaves, vegetables, fruits, spices, yeast, yeast extracts, and the like. Examples of the food additives include emulsifiers, antioxidants, silicones, dyes, flavorings, vitamins, and the like.

The types and amounts of the aforementioned food products and food additives can be set as appropriate according to an effect to be obtained. As a result of blending such food products and food additives together with the oil and/or fat composition according to the present invention, for example, an effect of adjusting flavor and color, an effect of suppressing oxidation and deterioration, an effect of improving functions, and the like can be exhibited.

From the viewpoint of facilitating exhibition of the effect of the present invention, it is preferable that the oil and/or fat composition according to the present invention is substantially or completely free from moisture. In the present invention, the phrase “the oil and/or fat composition is substantially free from moisture” means that a moisture content is 0.5% by mass or less based on the whole oil and/or fat composition. In the present invention, the phrase “the oil and/or fat composition is completely free from moisture” means that a moisture content is 0.0% by mass based on the whole oil and/or fat composition. In the present invention, the term “moisture” means water (H₂O). The moisture of the oil and/or fat composition according to the present invention can be measured in accordance with “Standard Methods for the Analysis of Fats, Oils and Related Materials 2.1.3.4-2013, Moisture (Karl-Fischer Method)”.

From the viewpoint of facilitating exhibition of the effect of the present invention, the oil and/or fat composition according to the present invention consists of the above four components (hydroxymethylfurfural, methional, phenylethanal, and ethanol) and an oil and/or fat, and need not contain any other components.

<Method for Manufacturing Oil and/or Fat Composition>

The oil and/or fat composition according to the present invention can be obtained by appropriately mixing and stirring each ingredient using a stirrer or the like. The order of mixing the ingredients, and the like are not particularly limited.

As described above, the oil and/or fat composition can contain the above four components (i.e. hydroxymethylfurfural, methional, phenylethanal, and ethanol) as synthetic products (commercially available reagents, fragrance ingredients, etc.), food or drink containing each component as a part thereof, or extracts, or the like.

As the aforementioned four ingredients, a food product containing all of the four ingredients may be used. Examples of such a food product include liquor (sake, Japanese spirits, wine, beer, whiskey, vodka, etc.), sweet sake (mirin), miso, soy sauce, soy sauce lees, malted rice, salted rice malt, sweet half sake, sake lees, sweet sake lees (mirin lees), vegetable pickled in sake lees (narazuke), honey, sugar, beef, potato, tomato, cheese, coffee, coffee grounds, buckwheat, chocolate, and the like, and a combination thereof. The above food products may be used as they are in an unprocessed state, or may be processed (heating, etc.) before use. For example, the food product is immersed in an oil and/or fat, then heated and filtered, so that the oil and/or fat composition according to the present invention can be obtained.

<Properties of Oil and/or Fat Composition>

The oil and/or fat composition according to the present invention has good richness and aroma, and a suppressed off-flavor. The presence and the degree of richness, aroma, and off-flavor of the oil and/or fat composition are identified by the method described in Examples.

<Applications of Oil and/or Fat Composition>

Applications of the oil and/or fat composition according to the present invention are not particularly limited. The oil and/or fat composition can be used as a substitute for a conventionally known flavored oil, or the like, or in combination with any seasoning (conventionally known flavored oil, etc.).

The oil and/or fat composition according to the present invention can be blended into any food or drink product to provide a good flavor (richness and aroma) with a suppressed off-flavor to the food or drink product and the like containing the composition. Thus, the present invention also includes the food or drink product containing the oil and/or fat composition according to the present invention.

Examples of the food or drink product and the like that can contain the oil and/or fat composition according to the present invention include, but are not particularly limited to, various dishes (fried foods, etc.), confectioneries, breads, and the like, which are made with an oil and/or fat. The oil and/or fat composition according to the present invention can also be used as a raw material for food products containing an oil and/or fat such as a plastic oil and/or fat composition, a frying oil, an edible oil and/or fat, a flavored edible oil, an oil-in-water emulsion (concentrated milk, whipped cream, mayonnaise, etc.), a powdered oil and/or fat, and a dressing. Among the above oils and/or fats, the plastic oil and/or fat composition is preferable as the food or drink product containing the oil and/or fat composition according to the present invention.

(Plastic Oil and/or Fat Composition)

Specific examples of the “plastic oil and/or fat composition” according to the present invention include margarine, fat spread, shortening, and the like. In the present invention, the term “plastic” means that the oil and/or fat composition contains a solid fat and has moderate flexibility so as to have a shape-changing property.

Examples of the form of the plastic oil and/or fat composition include, but are not limited to, a form that is substantially free from an aqueous phase, and a form including an aqueous phase. In the present invention, the phrase “substantially free from an aqueous phase” means that the moisture content (including volatile content) is 0.5% by mass or less based on the plastic oil and/or fat composition.

Examples of the plastic oil and/or fat composition that is substantially free from the aqueous phase include shortening (especially those meeting Japanese Agricultural Standards).

Examples of the plastic oil and/or fat composition including the aqueous phase include various types of plastic oil and/or fat compositions (water-in-oil type, oil-in-water type, oil-in-water-in-oil type, and water-in-oil-in-water type). As a plastic oil and/or fat composition including an aqueous phase, a water-in-oil type (margarine, etc.) is preferable. In the plastic oil and/or fat composition including the aqueous phase, an oil phase content is preferably 60% by mass or more and 99.4% by mass or less, more preferably 65% by mass or more and 98% by mass or less. In the plastic oil and/or fat composition including the aqueous phase, an aqueous phase content is preferably 0.6% by mass or more and 40% by mass or less, more preferably 2.0% by mass or more and 35% by mass or less.

When the oil and/or fat composition according to the present invention is blended into the plastic oil and/or fat composition, the blending amount of the oil and/or fat composition according to the present invention is not particularly limited. For example, the content of the oil and/or fat composition according to the present invention is preferably 1% by mass or more and 50% by mass or less, and more preferably 1% by mass or more and 30% by mass or less, based on the plastic oil and/or fat composition.

When the oil and/or fat composition according to the present invention is blended into the plastic oil and/or fat composition, a solid oil and/or fat is usually blended together with the oil and/or fat composition according to the present invention into the plastic oil and/or fat composition. The mixture thereof is cooled rapidly and kneaded to obtain the plastic oil and/or fat composition.

A saturated fatty acid content in the plastic oil and/or fat composition is preferably 20.0% by mass or more and 50.0% by mass or less, more preferably 30.0% by mass or more and 50.0% by mass or less. If the saturated fatty acid content is in this range, when a food product containing the plastic oil and/or fat composition is eaten, the saturated fatty acid remains in the mouth, and even in a state that the oil and/or fat composition according to the present invention is dispersed, it is easy to sense richness and aroma, and it is difficult to sense off-flavors. Examples of the oil type used for the saturated fatty acid content in the plastic oil and/or fat composition to be within the above range include, but are not limited to, vegetable oils and/or fats (rapeseed oil (canola oil), soybean oil, corn oil, coconut oil, cacao butter, palm oil, palm kernel oil, etc.), animal oils and/or fats (fish oil (oil and/or fat derived from tuna, mackerel, sardine, bonito, herring, etc.), lard, beef tallow, milk fat, mutton tallow, etc.). Also, these oils and/or fats that have been processed (fractionation, hardening, ester exchange, etc.) may be used. Among the above oils and/or fats, the palm-based oils and/or fats (palm oil, palm fractionated soft oil, and ester-exchanged oil of a palm fractionated soft part) are preferable from the viewpoint of facilitating exhibition of the effect of the present invention.

The lower limit of the hydroxymethylfurfural content in the plastic oil and/or fat composition is preferably 30 ppm or more from the viewpoint of facilitating exhibition of the effect of the present invention. The upper limit of the hydroxymethylfurfural content in the plastic oil and/or fat composition is preferably 1500 ppm or less from the viewpoint of facilitating exhibition of the effect of the present invention.

The lower limit of the methional content in the plastic oil and/or fat composition is preferably 0.05 ppm or more from the viewpoint of facilitating exhibition of the effect of the present invention. The upper limit of the methional content in the plastic oil and/or fat composition is preferably 2.5 ppm or less from the viewpoint of facilitating exhibition of the effect of the present invention.

The lower limit of the phenylethanal content in the plastic oil and/or fat composition is preferably 0.5 ppm or more from the viewpoint of facilitating exhibition of the effect of the present invention. The upper limit of the phenylethanal content in the plastic oil and/or fat composition is preferably 30 ppm or less from the viewpoint of facilitating exhibition of the effect of the present invention.

The lower limit of the ethanol content in the plastic oil and/or fat composition is preferably 60 ppm or more from the viewpoint of facilitating exhibition of the effect of the present invention. The upper limit of the ethanol content in the plastic oil and/or fat composition is preferably 3500 ppm or less from the viewpoint of facilitating exhibition of the effect of the present invention.

(Method for Manufacturing Plastic Oil and/or Fat Composition)

The plastic oil and/or fat composition according to the present invention can be manufactured by a known method. For example, the plastic oil and/or fat composition according to the present invention can be obtained by appropriately heating and mixing the constituent ingredients and then cooling rapidly and kneading them using a cooling mixer (combinator, perfector, votator, nexus, etc.). If necessary, inert gas (nitrogen gas, etc.) may be blown into the cooling mixer, or the plastic oil and/or fat composition may be matured (tempering) after the rapid cooling and kneading.

### Examples

In Examples below, the present invention will be explained in more detail, but the present invention is not limited to Examples.

<Test 1: Preparation and Evaluation of Oil and/or Fat Composition>

Oil and/or fat compositions were prepared according to the following method, and flavors of the oil and/or fat compositions were evaluated.

(Preparation of Oil and/or Fat Composition)

For the oils and/or fats listed in the column “Oil and/or fat” in Tables 1 to 5, the respective ingredients were mixed and stirred so as to be in the concentrations listed in each table to prepare oil and/or fat compositions of Examples and Comparative Examples.

Both the “rapeseed oil” (canola oil) and the “rice bran oil” used in this example have a solid fat content of 3% or less at 10° C.

In Tables 1 to 5, units of the values listed in the respective columns “Hydroxymethylfurfural”, “Methional”, “Phenylethanal”, and “Ethanol” are all “ppm”.

In Tables 1 to 5, “EtOH/HMF” refers to a mass ratio of ethanol to hydroxymethylfurfural in each composition.

The oil and/or fat composition of “Comparative Example 1-1” consists only of rapeseed oil, and the oil and/or fat composition of “Comparative Example 1-7” consists only of lard.

(Evaluation of Oil and/or Fat Composition)

The obtained oil and/or fat compositions were subjected to a sensory evaluation for richness, aroma, and off-flavor based on the following conditions. Results of the evaluation are presented in the column “Evaluation” in Tables 1 to 5.

The sensory evaluation (evaluation of various flavors) was performed on panelists selected as below. On candidates for the panelists, a five-taste (sweetness, sourness, salty, bitterness, and umami) discrimination test, a taste concentration-difference discrimination test, a food taste discrimination test, and a standard smell test were conducted, and 20 persons who were judged to be suitable for each test were selected as the panelists. Before the evaluation, all panelists discussed and got alignment on the property of each evaluation item so that the respective panelists had a common understanding. In order to eliminate a bias of each panelist in the sensory evaluation and to improve the evaluation accuracy, the test section numbers and contents of the samples were not informed to the panelists and presented randomly.

### [Evaluation Method]

The panelists (20 persons in total) were made to answer whether they sensed each of three flavors (“richness”, “aroma”, and “off-flavor” as defined in the present invention) when they took each oil and/or fat composition (1 g) in their mouths. The oil and/or fat composition was evaluated based on their answers, according to the following evaluation criteria. In each evaluation criterion, “⊙+” represents the best result, and “X” represents the worst result. A result of “◯” or better in each evaluation item was judged as sufficiently desirable.

### [Evaluation Criteria (Richness)]

⊙+: 17 or more of 20 panelists answered that they sensed richness.
⊙: 13 or more and 16 or less of 20 panelists answered that they sensed richness.
◯: 9 or more and 12 or less of 20 panelists answered that they sensed richness.
Δ: 5 or more and 8 or less of 20 panelists answered that they sensed richness.
X: 4 or less of 20 panelists answered that they sensed richness.

### [Evaluation Criteria (Aroma)]

⊙+: 17 or more of 20 panelists answered that they sensed aroma.
⊙: 13 or more and 16 or less of 20 panelists answered that they sensed aroma.
◯: 9 or more and 12 or less of 20 panelists answered that they sensed aroma.
Δ: 5 or more and 8 or less of 20 panelists answered that they sensed aroma.
X: 4 or less of 20 panelists answered that they sensed aroma.

### [Evaluation Criteria (Off-Flavor)]

⊙+: 17 or more of 20 panelists answered that they sensed no off-flavor.
⊙: 13 or more and 16 or less of 20 panelists answered that they sensed no off-flavor.
◯: 9 or more and 12 or less of 20 panelists answered that they sensed no off-flavor.
Δ: 5 or more and 8 or less of 20 panelists answered that they sensed no off-flavor.
X: 4 or less of 20 panelists answered that they sensed no off-flavor.

TABLE 1

| | | Example | Example | Example | Example | Example | Example | Example | Example | Example | Example | Example |
|---|---|---|---|---|---|---|---|---|---|---|---|---|
| | | 1-1 | 3-2 | 1-3 | 1-4 | 1-5 | 1-6 | 1-7 | 1-8 | 1-9 | 3-10 | 1-11 |
| Oil and/or fat | | Rape- | Rape- | Rape- | Rape- | Rape- | Rape- | Rape- | Rape- | Rape- | Rape- | Rape- |
| | | seed | seed | seed | seed | seed | seed | seed | seed | seed | seed | seed |
| | | oil | oil | oil | oil | oil | oil | oil | oil | oil | oil | oil |
| Hydroxy- | | 100 | 3000 | 7000 | 3000 | 3000 | 3000 | 3000 | 3000 | 3000 | 100 | 1000 |
| methyl- | | | | | | | | | | | | |
| furfural | | | | | | | | | | | | |
| Methional | | 1 | 1 | 1 | 5 | 5 | 5 | 10 | 100 | 200 | 5 | 5 |
| Phenylethanal | | 10 | 10 | 10 | 1.0 | 60 | 110 | 10 | 10 | 10 | 60 | 60 |
| Ethanol | | 1500 | 1500 | 1500 | 1500 | 1500 | 1500 | 1500 | 1500 | 1500 | 7000 | 7000 |
| ETOH/HMF | | 15.00 | 0.50 | 0.21 | 0.50 | 0.50 | 0.50 | 0.50 | 0.50 | 0.50 | 70.00 | 7.00 |
| Evalu- | Rich- | ◯ | ⊚ | ⊚ | ⊚ | ⊚ | ⊚ | ⊚ | ⊚ | ⊚ | ◯ | ⊚ |
| ation | ness | | | | | | | | | | | |
| | Aroma | ◯ | ◯ | ◯ | ⊚ | ⊚ | ⊚ | ⊚ | ⊚ | ⊚ | ⊚+ | ⊚+ |
| | Off- | ⊚ | ⊚ | ◯ | ⊚ | ⊚ | ◯ | ⊚ | ⊚ | ◯ | ⊚ | ⊚+ |
| | flavor | | | | | | | | | | | |

TABLE 2

| | | Example | Example | Example | Example | Example |
|---|---|---|---|---|---|---|
| | | 1-12 | 1-13 | 1-14 | 1-15 | 1-16 |
| Oil and/or fat | | Rape- | Rape- | Rape- | Rape- | Rape- |
| | | seed | seed | seed | seed | seed |
| | | oil | oil | oil | oil | oil |
| Hydroxy- | | 3000 | 3000 | 3000 | 3000 | 3000 |
| methyl- | | | | | | |
| furfural | | | | | | |
| Methional | | 5 | 5 | 5 | 5 | 5 |
| Phenylethanal | | 60 | 5 | 10 | 100 | 150 |
| Ethanol | | 7000 | 7000 | 7000 | 7000 | 7000 |
| EtOH/HMF | | 2.33 | 2.33 | 2.33 | 2.33 | 2.33 |
| Evalu- | Rich- | ⊚+ | ⊚+ | ⊚+ | ⊚ | ⊚ |
| ation | ness | ⊚+ | ◯ | ⊚ | ⊚+ | ⊚ |
| | Aroma | ⊚+ | ⊚+ | ⊚+ | ⊚ | ◯ |
| | Off- | | | | | |
| | flavor | | | | | |

TABLE 3

| | | Example | Example | Example | Example | Example | Example | Example |
|---|---|---|---|---|---|---|---|---|
| | | 1-17 | 1-18 | 1-19 | 1-20 | 1-21 | 1-22 | 1-23 |
| Oil and/or fat | | Rapeseed | Rapeseed | Rapeseed | Rapeseed | Rapeseed | Rapeseed | Rapeseed |
| | | oil | oil | oil | oil | oil | oil | oil |
| Hydroxymethyl- | | 5000 | 7000 | 7000 | 3000 | 3000 | 3000 | 100 |
| furfural | | | | | | | | |
| Methional | | 5 | 5 | 5 | 5 | 5 | 5 | 1 |
| Phenylethanal | | 60 | 60 | 60 | 60 | 60 | 60 | 10 |
| Ethanol | | 7000 | 7000 | 1000 | 1000 | 12000 | 15000 | 12000 |
| EtOH/HMF | | 1.40 | 1.00 | 0.14 | 0.33 | 4.00 | 5.00 | 120.00 |
| Evalu- | Richness | ⊚+ | ⊚+ | ◯ | ◯ | ⊚+ | ⊚+ | ◯ |
| ation | Aroma | ⊚+ | ⊚ | ◯ | ◯ | ⊚+ | ⊚+ | ◯ |
| | Off-flavor | ⊚+ | ◯ | ◯ | ⊚ | ⊚ | ◯ | ◯ |

TABLE 4

| | | | Example 1-24 |
|---|---|---|---|
| Oil and/or fat | | | Rice bran oil |
| Hydroxymethylfurfural | | | 3000 |
| Methional | | | 5 |
| Phenylethanal | | | 60 |
| Ethanol | | | 7000 |
| EtOH/HMF | | | 2.33 |
| | Evaluation | Richness | ⊚+ |
| | | Aroma | ⊚+ |
| | | Off-flavor | ⊚+ |

TABLE 5

| | | Comparative | Comparative | Comparative | Comparative | Comparative | Comparative | Comparative |
|---|---|---|---|---|---|---|---|---|
| | | Example | Example | Example | Example | Example | Example | Example |
| | | 1-1 | 1-2 | 1-3 | 1-4 | 1-5 | 1-6 | 1-7 |
| Oil and/or fat | | Rapeseed | Rapeseed | Rapeseed | Rapeseed | Rapeseed | Rapeseed | Lard |
| | | oil | oil | oil | oil | oil | oil | |
| Hydroxymethyl- | | 0 | 80 | 8000 | 3000 | 3000 | 3000 | 0 |
| furfural | | | | | | | | |
| Methional | | 0 | 5 | 5 | 0.8 | 5 | 5 | 0 |
| Phenylethanal | | 0 | 60 | 60 | 60 | 0 | 60 | 0 |
| Ethanol | | 0 | 7000 | 7000 | 7000 | 7000 | 0 | 0 |
| EtOH/HMF | | — | 87.50 | 0.88 | 2.33 | 2.33 | 0.00 | — |
| Evalu- | Richness | X | Δ | ⊚+ | ⊚ | ⊚ | ◯ | Δ |
| ation | Aroma | X | Δ | ◯ | Δ | Δ | ◯ | Δ |
| | Off-flavor | ⊚ | ⊚+ | Δ | ⊚ | ⊚+ | Δ | ⊚ |

As presented in Tables 1 to 4, the oil and/or fat compositions that satisfy all requirements of the present invention were excellent in richness and aroma, and had little off-flavor.

When the phenylethanal content in the oil and/or fat composition was 7 ppm or more and 140 ppm or less, or when the ethanol content in the oil and/or fat composition was 1100 ppm or more and 14000 ppm or less, the oil and/or fat composition tended to be excellent particularly in richness and aroma and have less off flavor.

On the other hand, as presented in Table 5, the oil and/or fat compositions that did not satisfy any or all of the requirements of the present invention were poor in richness and/or aroma, or had a strong off-flavor.

### <Test 2: Preparation and Evaluation of Dish—1>

The oil and/or fat compositions prepared in Test 1 above were used to prepare dishes (fried foods), and their flavors were evaluated.

### (Preparation of Fried Food)

Using each oil and/or fat composition as frying oil, commercially available frozen croquettes were deep-fried at 180° C. for 3 minutes to prepare croquettes (corresponding to fried foods).

The oil and/or fat compositions used in this test are listed in the column “Oil and/or fat composition” in Table 6. For example, in “Example 2-1”, the oil and/or fat composition obtained in “Example 1-8” was used.

### (Evaluation of Fried Food)

The obtained fried foods were evaluated for richness, aroma, and off-flavor in the same manner as in Test 1. The results are presented in the column “Evaluation” in Table 6.

TABLE 6

| | | Example | Example | Example | Comparative |
|---|---|---|---|---|---|
| | | 2-1 | 2-2 | 2-3 | Example 2-1 |
| Oil and/or fat | | Example | Example | Example | Comparative |
| composition | | 1-8 | 1-12 | 1-19 | Example 1-1 |
| Evaluation | Richness | ⊚ | ⊚+ | ◯ | X |
| | Aroma | ⊚ | ⊚+ | ◯ | X |
| | Off-flavor | ⊚ | ⊚+ | ◯ | ⊚ |

As presented in Table 6, the oil and/or fat compositions that satisfied all requirements of the present invention maintained good flavor even when used for preparing the fried foods.

When the oil and/or fat composition was used to prepare other dishes (fried rice, curry roux, soybean hamburger steak, and soup) instead of the fried foods, the results similar to those obtained for the fried foods were obtained.

<Test 3: Preparation of Plastic Oil and/or Fat Composition (Shortening)>

The oil and/or fat composition obtained in “Examples 1-12” (12.0% by mass) was blended into palm oil (88.0% by mass), which was cooled rapidly and kneaded according to a conventional method to obtain a “plastic oil and/or fat composition 1”. The oil and/or fat composition obtained in “Example 1-12” (2.0% by mass) was blended into palm oil (98.0% by mass), which was cooled rapidly and kneaded according to a conventional method to obtain a “plastic oil and/or fat composition 2”.

The compositions of the “plastic oil and/or fat composition 1” and “plastic oil and/or fat composition 2” are listed in Table 7.

TABLE 7

| | Plastic oil and/or | Plastic oil and/or |
|---|---|---|
| | fat composition 1 | fat composition 2 |
| Hydroxymethylfurfural (ppm) | 360 | 60 |
| Methional (ppm) | 0.6 | 0.1 |
| Phenylethanal (ppm) | 7.2 | 1.2 |
| Ethanol (ppm) | 840 | 140 |
| Saturated fatty acid (% by mass) | 44.4 | 48.9 |

### <Test 4: Preparation and Evaluation of Dish—2>

The plastic oil and/or fat composition prepared in Test 3 above was used to prepare a dish (soybean hamburger steak), and its flavor was evaluated.

### (Preparation of Soybean Hamburger Steak)

Soybean hamburger steak was prepared based on the formulations (% by mass) in Table 8 according to the following method.
(1) A granular soybean protein was rehydrated with water.
(2) Salt, spices, and potato starch were homogeneously mixed into the granular soybean protein.
(3) The granular soybean protein in the above (1), soybean curd, the plastic oil and/or fat composition 1 or 2, or palm oil were mixed together.
(4) 80 g of the mixture was shaped and then baked in a convection oven at 195° C. for 10 minutes.

The “soybean curd” in Table 8 was prepared based on the formulation (% by mass) in Table 9 according to the following method.
(1) Powdered soybean protein and methylcellulose were mixed, and rapeseed oil was added to the mixture, which was homogeneously beaten using a food processor.
(2) To the mixture, water (cold water) was gradually added while beating, to emulsify the mixture.
(3) The mixture was cooled in a refrigerator for at least 30 minutes.

### (Evaluation of Soybean Hamburger Steak)

The prepared soybean hamburger steak was evaluated for richness, aroma, and off-flavor in the same manner as in Test 1. In the evaluation, “Reference Example 1” in which palm oil was used instead of the plastic oil and/or fat composition was set for comparison. The results are presented in the column “Evaluation” in Table 8.

TABLE 8

| | | Example | Example | Reference |
|---|---|---|---|---|
| | | 3-1 | 3-2 | Example 1 |
| Plastic oil and/or fat composition1 | | 8.8 | | |
| Plastic oil and/or fat composition2 | | | 8.8 | |
| Palm oil | | | | 8.8 |
| Granular soybean protein (*1) | | 19 | 19 | 19 |
| Soybean curd | | 31 | 31 | 31 |
| Potato starch | | 2 | 2 | 2 |
| Salt | | 1 | 1 | 1 |
| Spice | | 0.2 | 0.2 | 0.2 |
| Water | | 38 | 38 | 38 |
| Total | | 100 | 100 | 100 |
| Evaluation | Richness | ⊚+ | ◯ | X |
| | Aroma | ⊚+ | ◯ | X |
| | Off-flavor | ⊚+ | ◯ | X |

(*1) NEW SOIMI S 21WA (The Nisshin Oillio Group, Ltd.)

TABLE 9

| | | |
|---|---|---|
| Soybean curd | Powdery soybean protein (*1) | 10 |
| | Rapeseed oil | 10 |
| | Water | 78 |
| | Methyl cellulose (*2) | 2 |

(*1) SOLPEA 6000H (The Nisshin Oillio Group, Ltd.)
(*2) METOLOSE MCE100TS (Shin-Etsu Chemical Co., Ltd.)

1. An oil and/or fat composition comprising:
hydroxymethylfurfural, methional, phenylethanal, and ethanol,
wherein a content of the hydroxymethylfurfural in the oil and/or fat composition is 100 ppm or more and 7,000 ppm or less;
a content of the methional in the oil and/or fat composition is 1 ppm or more;
and the oil and/or fat composition has a solid fat content of 10% or less at 10° C.

2. The oil and/or fat composition according to claim 1, wherein the phenylethanal content in the oil and/or fat composition is 7 ppm or more and 140 ppm or less.

3. The oil and/or fat composition according to claim 1, wherein the ethanol content in the oil and/or fat composition is 1,100 ppm or more and 14,000 ppm or less.

4. The oil and/or fat composition according to claim 1, wherein a mass ratio of the ethanol to the hydroxymethylfurfural is 0.30 or more and 100.00 or less.

5. A food or drink product comprising the oil and/or fat composition according to claim 1.

6. The food or drink product according to claim 5, wherein the food or drink product is a plastic oil and/or fat composition.
